(19) United States
(12) Patent Application Publication
(10) Pub. No.: US 2010/0323077 A1
(43) Pub. Date: Dec. 23, 2010

(54) FOOD SUBSTANCE FLIPPING SYSTEM, METHOD AND APPARATUS

(75) Inventor: Jung S. Moon, Buffalo Grove, IL (US)

Correspondence Address: VENABLE LLP, P.O. BOX 34385, WASHINGTON, DC, 20043-9998, US

(73) Assignee: IBC-Hearthware, Inc., Gurnee, IL (US)

(21) Appl. No.: 12/486,391

(22) Filed: Jun. 17, 2009

(51) Int. Cl. A47J 43/28; A47J 37/00; A23L 1/01

(52) U.S. Cl. 426/523; 99/448

(57) ABSTRACT

A food substance flipping apparatus including a handle support member fixedly attached to a handle of the flipping apparatus and an outer support member coupled to the handle support member disposable to engage the food substance.

### BACKGROUND

1. Field of the Invention

The present invention relates generally to grasping elements and more particularly to an apparatus for handling food being baked.

2. Related Art

Pizza is a popular food prepared at home. Typically, pizza is baked by placing the pizza right side up in a conventional oven. Recently however, ovens primarily heating from the top have been introduced. The standard method of baking a pizza does not produce adequate results in some top heating ovens as the top of the pizza may receive more heat, usually resulting in an overcooked pizza top or an undercooked pizza crust. What is needed is a method for baking a pizza that overcomes the shortcomings of conventional pizza baking methods.

### SUMMARY OF THE INVENTION

The present invention sets forth various exemplary embodiments of apparatuses, methods and systems for baking a pizza or other food substance.

A food substance flipping apparatus, may include a handle support member fixedly attached to a handle of the flipping apparatus and an outer support member coupled to the handle support member disposable to engage a food substance.

The outer support member may be coupled to the handle support member by an inner support member fixedly attaching the handle support member to the outer support member.

The food substance flipping apparatus may further include a second handle support member fixedly attached to the handle of the flipping apparatus, and a second outer support member coupled to the second handle support member disposable to engage the food substance.

The second outer support member may be coupled to the second handle support member by an inner support member fixedly attaching the second handle support member to the second outer support member. The handle may include a first handle portion coupled to the handle support member and a second handle portion coupled to the second handle support member. The first handle portion and the second handle portion may be coupled on an end of the handle distal from the handle support member. The first handle portion and the second handle portion may be coupled by a hinged connection.

The food substance flipping apparatus may further include a resilient member biased to separate the outer support member and the second outer support member.

The food substance flipping apparatus may further include a locking mechanism adapted to lock the outer support member in a predetermined position with respect to the second outer support member. The locking mechanism may include a column extending from the second handle portion and including at least one slot, and a sliding tab located on the first handle portion and engagable with the slot. The outer support member may be shaped substantially circular.

The outer support member may define a surface area enclosed by the member, wherein the surface area comprises at most about 20% of support members. The outer support member may include cast iron wire.

The shape of the handle support member may be substantially u-shaped. The shape of the inner support member may be substantially curved.

A method of baking a pizza may include placing a pizza on a rack surface of an oven, partially baking the pizza, flipping the partially baked pizza over with a food substance flipping apparatus and replacing the partially baked pizza on the rack surface, and continuing to bake the pizza.

The method may further include covering a top of the pizza with an inner nonstick surface of a cover before flipping the pizza. The cover may include parchment paper. The inner nonstick surface may include at least one of: silicone, enamel, teflon and metal. The cover may include a re-usable dish.

The cover may include a silicone dish including the inner nonstick surface substantially shaped like a pizza, a cover wall with a plurality of vertical reinforcing ridges, the cover wall bordering the edges of the inner nonstick surface, and one or more handles extending from the cover wall.

The method may further include placing a cover on a pizza, then placing the cover on the rack surface with a inner nonstick surface of the cover facing upwards with the pizza placed upside down on the rack surface with an inner nonstick surface of the cover, positioning the food substance flipping apparatus between the cover and the rack surface, and over the partially baked pizza after partially baking, engaging the partially baked pizza with the food substance flipping apparatus, flipping the partially baked pizza with the food substance flipping apparatus, replacing the partially baked pizza on the rack surface, and subsequently removing the cover.

Baking the pizza may include heating the pizza with a heating element suspended above the pizza.

The foregoing embodiments, together with embodiments directed to methods and computer program products thereof, are described in greater detail below.

### BRIEF DESCRIPTION OF THE FIGURES

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of an isometric view of an exemplary food substance flipping apparatus in an exemplary open position according to an exemplary embodiment of the present invention;

FIG. 2 depicts an exemplary embodiment of an isometric view of the exemplary food substance flipping apparatus of FIG. 1, shown in an exemplary closed position according to an exemplary embodiment of the present invention;

FIG. 3 depicts an exemplary embodiment of a top plan view of a food substance flipping apparatus according to an exemplary embodiment of the present invention;

FIG. 4 depicts an exemplary embodiment of an isometric view of an exemplary alternative configuration of a food substance flipping apparatus according to an exemplary embodiment of the present invention;

FIG. 5 depicts an exemplary embodiment of an enlarged partial isometric view of an exemplary handle of an exemplary food substance flipping apparatus according to an exemplary embodiment of the present invention;

FIGS. 6A-B depict an exemplary embodiment of a side view of a pizza placed on an exemplary cover placed on an exemplary oven rack according to an exemplary embodiment of the present invention;

FIG. 7 depicts an exemplary embodiment of a isometric view of an exemplary food substance cover according to an exemplary embodiment of the present invention;

FIG. 8 depicts an exemplary embodiment of an exemplary side view of an exemplary food substance cover according to an exemplary embodiment of the present invention;

FIG. 9 depicts an exemplary embodiment of an exemplary image illustrating an exemplary isometric view of exemplary surfaces of an exemplary food substance flipping apparatus being used to grasp a pizza and cover according to an exemplary embodiment of the present invention;

FIG. 10 depicts an exemplary embodiment of an exemplary image illustrating an isometric view of a user flipping a pizza with an exemplary food substance flipping apparatus according to an exemplary embodiment of the present invention;

FIG. 11 depicts an exemplary embodiment of an exemplary image illustrating an isometric view of a user placing a flipped pizza back in an oven with an exemplary food substance flipping apparatus according to an exemplary embodiment of the present invention;

FIG. 12 depicts an exemplary embodiment of an exemplary image illustrating an isometric view of a user removing a cover from a pizza according to an exemplary embodiment of the present invention.

FIG. 13 depicts an exemplary embodiment of an exemplary flowchart of an exemplary method of baking pizza with a food substance flipping apparatus according to an exemplary embodiment of the present invention; and

FIG. 14 depicts an exemplary embodiment of an exemplary flowchart of an exemplary expanded method of baking pizza with a food substance flipping apparatus according to an exemplary embodiment of the present invention.

### DETAILED DESCRIPTION OF VARIOUS EXEMPLARY EMBODIMENTS OF THE INVENTION

Various exemplary embodiments, including any preferred exemplary embodiments of the invention are discussed in detail below. While specific exemplary embodiments are discussed, it should be understood that this is done for illustration purposes only. A person skilled in the relevant art will recognize that other components and configurations may be used without parting from the spirit and scope of the invention.

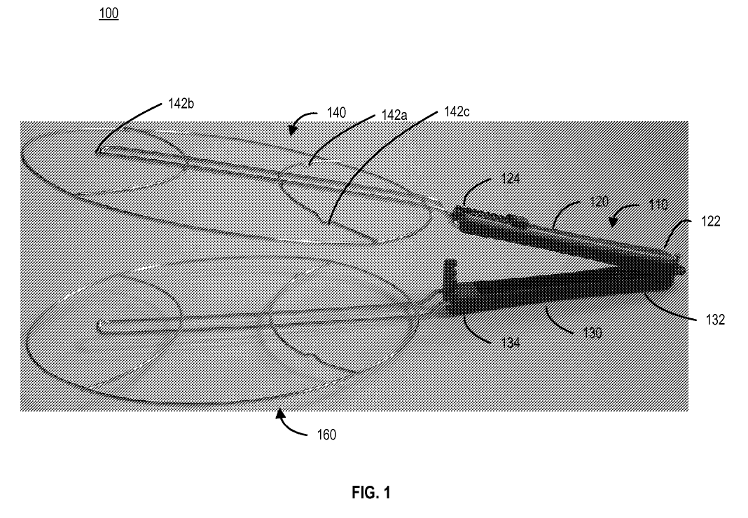

FIG. 1 depicts an exemplary embodiment of an isometric view of an exemplary food substance flipping apparatus 100 according to an exemplary embodiment of the present invention. In an exemplary embodiment, the food substance flipping apparatus 100 may be used to grasp food substance and turn over the food substance. According to an exemplary embodiment, a food substance flipping apparatus 100 may include a handle 110. In an exemplary embodiment, the handle may have a first handle portion 120. According to an exemplary embodiment, the first handle portion 120 may include a proximal end 122 and a distal end 124. According to an exemplary embodiment, the handle may have a second handle portion 130. In an exemplary embodiment, the second handle portion 130 may include a proximal end 132 and a distal end 134. In an exemplary embodiment, the proximal end 122 of the first handle portion 120 may pivotably couple with the proximal end 132 of the second handle portion 130. In an exemplary embodiment, a first surface 140 may be connected or coupled to the distal end 124 of the first handle portion 120. According to an exemplary embodiment, a second surface 160 may be connected or coupled to the distal end 134 of the second handle portion 130. According to an exemplary embodiment, the first surface 140 and/or the second surface 160 may include one or more focal grasping points 142a, 142b, 142c (hereinafter collectively 142) for grasping a food substance. According to an exemplary embodiment, the first surface 140 may be designed to have minimal surface contact with a food substance but may evenly provide support to the food substance during flipping of the food substance. As depicted in an exemplary embodiment, grasping points 142 may be arranged to create an approximately equilateral triangle on the exemplary circular first surface 140.

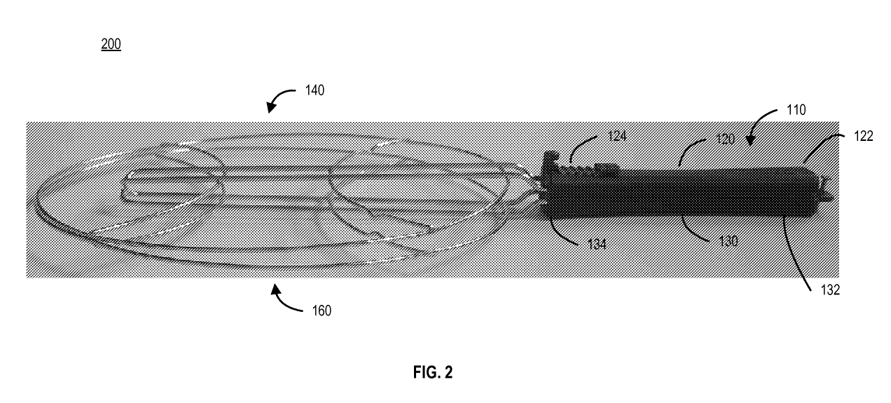

FIG. 2 depicts an exemplary embodiment of an isometric view 200 of the food substance flipping apparatus of FIG. 1, shown in an exemplary closed position according to an exemplary embodiment of the present invention. In an exemplary embodiment, the first handle portion 120 and the second handle portion 130 may close together. According to an exemplary embodiment, the first handle portion 120 and second handle portion 130 may close together by pivoting about their coupled proximal ends 122 and 132. In an exemplary embodiment, the food substance may be located between the first 140 and second 160 surfaces of the food substance flipping apparatus 100 in a closed position. According to an exemplary embodiment, the distance between the first 140 and second 160 surface of the food substance flipping apparatus 100 in a closed position may depend on the thickness of a food substance between the two surfaces. According to an exemplary embodiment, there may be a plurality of closed positions of varying spacings between the first and second surfaces 140, 160.

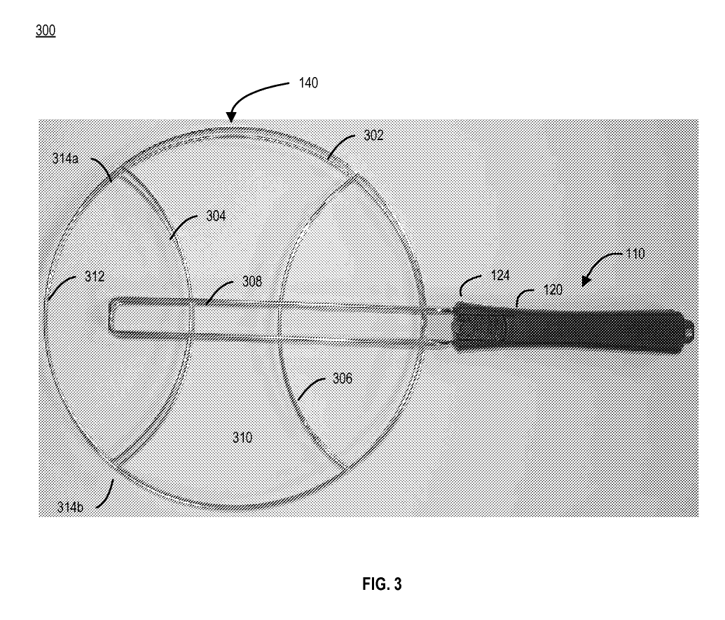

FIG. 3 depicts an exemplary embodiment of an exemplary top plan view 300 of a food substance flipping apparatus according to an exemplary embodiment of the present invention. According to an exemplary embodiment, an exemplary first surface 140 may include a handle support member 308 fixedly attached to a handle 110, an outer support member 302 connected or coupled to the handle support member, a first inner support member 304 extending across the outer support member 302, and a second inner support member 306 extending across the outer support member 302.

In an exemplary embodiment, the outer support member 302 may support a food substance by approximating the shape of the food substance. According to an exemplary embodiment, the outer support member 302 may define a surface area 310 of the first surface 140. According to an exemplary embodiment, the surface area 310 of the first surface 140 may be at least 80% open space. In an exemplary embodiment, the outer support member 302 may be of any shape including, e.g., but not limited to: circular, octagonal, hexagonal, pentagonal, polygonal, square, rectangular, or any other shape, etc. According to an exemplary embodiment, as depicted in FIG. 3, the outer support member 302 may be circular and may have a perimeter approximately 25″ in length.

In an exemplary embodiment, a first inner support member 304 may couple the handle support member 308 to the outer support member 302 and may be further adapted to support a food substance. According to an exemplary embodiment, the exemplary first inner support member 304 may be substantially curved. In an exemplary embodiment, an exemplary first inner support member 304 may be a member formed in an exemplary arc shape with an arc length of approximately 8″. According to an exemplary embodiment, the first inner support member 304 may have an arc degree substantially similar to the arc degree of an arc 312 formed by the two ends 314a and 314b of the first inner support member 304. According to an exemplary embodiment, the first inner support member 304 may have one or more concave portions forming grasping focal points 142 (not shown), such as those shown on exemplary arc shaped inner support member 306, as shown and described further with respect to FIG. 1 above. In an exemplary embodiment, the second inner support member 306 may be substantially similar to the first inner support member 304, but extending across a different portion of the outer support member 302. Second inner support member 306, as shown in FIG. 1, may include one or more grasping focal points 142.

According to an exemplary embodiment, the handle support member 308 may couple the handle 110 to the first surface 140 and may be used to grasp or support a food substance. In an exemplary embodiment, the handle support member 308 may be “U” shaped or rectangular in an exemplary embodiment with the member's two ends connected or coupled to the first handle portion 120 at distal end 124, as depicted. In an exemplary embodiment, the handle support member 308 may be approximately 7″ long and 1″ wide. According to an exemplary embodiment, the portion of the handle support member 308 farthest from the handle may have one or more concave portions forming one or more grasping focal points 142 as shown in FIG. 1. In an exemplary embodiment, the support members may comprise cast iron or steel wire. According to an exemplary embodiment, the support members may also be coated with a non-stick coating. In an exemplary embodiment, the second surface 160 may be substantially similar to and a mirror image of the first surface 140.

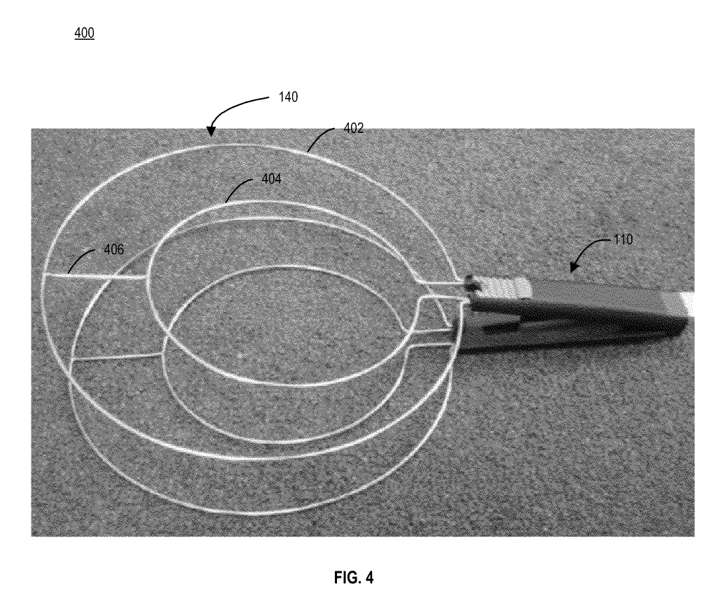

FIG. 4 depicts an exemplary embodiment of an isometric view 400 of an alternative configuration of an exemplary first surface of a food substance flipping apparatus according to another exemplary embodiment of the present invention. In an exemplary embodiment, the first surface 140 may include an exemplary substantially circular outer support member 402, an exemplary inner substantially circular handle support member 404 located within the outer support member 402, and may include an exemplary cross support member 406, which may extend between the outer support member 402 and the handle support member 404 for added stability and rigidity when used to grasp an exemplary food substance. According to an exemplary embodiment, the handle support member 404 may provide support for a food substance and may be connected or coupled to the handle 110. According to an exemplary embodiment, the cross support member 406 may provide support for a food substance and may connect or couple the outer support member 402 and the handle support member 404 at the respective points 124, 134 in each support member farthest from the handle (not shown, but illustrated in alternative embodiment depicted in FIG. 1).

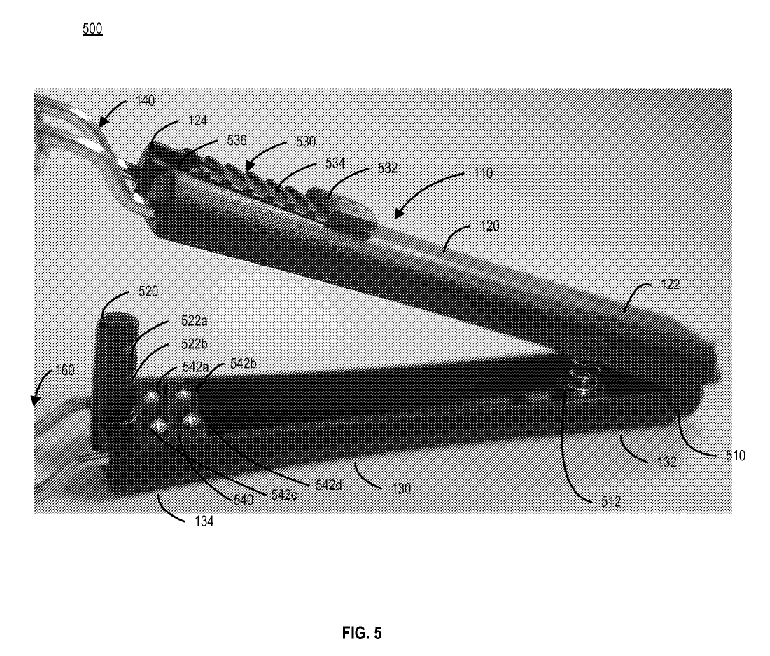

FIG. 5 depicts an exemplary embodiment of an enlarged partial isometric view 500 of an exemplary alternative handle 110 of a food substance flipping apparatus 100 according to an exemplary embodiment of the present invention. In an exemplary embodiment, the handle 110 may couple the first surface 140 and the second surface 160 so that they may cooperatively engage a food substance. According to an exemplary embodiment, the handle 110 may include a hinge 510 rotatably connecting or coupling the first handle portion 120 and the second handle portion 130. In an exemplary embodiment, the hinge 510 may be a revolute joint. According to an exemplary embodiment, the hinge 510 may include a guide hole (not shown) on each side of the proximal end 122 of the second handle portion 130. In an exemplary embodiment, the hinge 510 may include a projection (not shown) on each side of the proximal end 122 of the first handle portion 120 for entering the guide hole (not shown) in the respective side of each side of the proximal end 122 of the second handle portion 130. According to an exemplary embodiment, the handle 110 may be adjusted to fit pizzas or other food substances of different thicknesses. In an exemplary embodiment, the handle 110 may be adjusted by bringing the first surface 140 and the second surface 160 together to different distances of separation.

According to an exemplary embodiment, the handle 110 may include a resilient member biased to separate the outer support member 302 of a first surface 140 and outer support member 302 of a second surface 160. In an exemplary embodiment, the resilient member may be a spring 512 located between the first handle portion 120 and the second handle portion 130 biasing the handle 110 open when the spring is not compressed. In an exemplary embodiment, the spring 512 may be oriented vertically or horizontally in respect to the handle portions. According to an exemplary embodiment, the first handle portion 120 and the second handle portion 130 may be a single member and the resilient member may be an elastic portion of the member connecting or coupling the first handle portion 120 and the second handle portion 130 to one another. In an exemplary embodiment, a user may squeeze the handle 110 against the bias of the resilient member, compressing the exemplary spring, to bring the first surface 140 and second surface 160 together.

According to an exemplary embodiment, the handle 110 may include a locking mechanism (520 and 530), which may be adapted to lock the first surface 140 in a predetermined position with respect to the second surface 160. In an exemplary embodiment, the locking mechanism may include a column 520 extending from the second handle portion 130. According to an exemplary embodiment, the column 520 may include one or more slots 522a and 522b (hereinafter collectively referred to as 522). In an exemplary embodiment, the locking mechanism may include a sliding tab 530 on the first handle portion 120 and may be engagable with a slot 522 to fix the handle to one of a plurality of spacings, in one of two exemplary spacings in the exemplary embodiment. According to an exemplary embodiment, the sliding tab 530 may include a grooved portion 534 and may include a raised platform 532. In an exemplary embodiment, the grooved portion 534 and raised platform 532 may provide a gripping surface for a user to slide the tab 530. According to an exemplary embodiment, the first handle portion 120 may include a hollow 536 the column 520 may enter when the handle 110 is closed. In an exemplary embodiment, when the handle 110 is closed, the sliding tab 530 may be moved to engage a slot 522 in the column 520, locking the first surface 140 in a predetermined position with respect to the second surface 160.

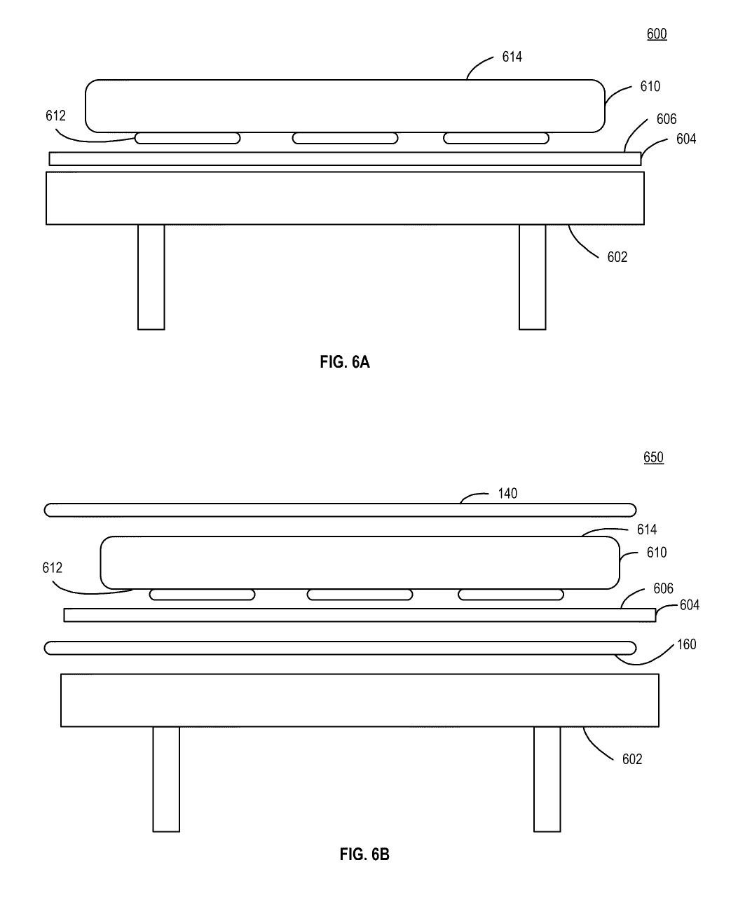

According to an exemplary embodiment, the first surface 140 and the second surface 160 may be permanently encased in the first handle portion 120 and the second handle portion 130. In another exemplary embodiment, the first surface 140 and/or the second surface may be detachably coupled to their respective handle portions. According to one exemplary embodiment, the surfaces 140, 160 may be removed from a handle 110 and/or attached to a handle 110. The second surface 160 may be held in place to a handle by, e.g., an exemplary handle cover 540. According to an exemplary embodiment, the handle cover 540 may be removably affixed, as shown, to couple surface 160 to the second handle portion 130 by one or more screws 542a, 542b, 542c and 542d (collectively 542). FIGS. 6A and 6B depict an exemplary embodiment of a side view 600, 650, respectively, of an inverted pizza 610 positioned on an exemplary food substance cover 604, positioned on an oven rack 602 according to an exemplary embodiment of the present invention. According to an exemplary embodiment, the food substance cover 604 may allow a food substance to be easily removed from the oven rack 602 and turned over. According to an exemplary embodiment, the cover 604 may be, e.g., but not limited to, parchment paper or a re-usable dish. In an exemplary embodiment, the cover may be made from, e.g., but not limited to, silicone, enamel, teflon, metal or any other non-stick material, etc.

In an exemplary embodiment, a rack surface 602 of an oven may support a cover 604 with a non-stick inner surface 606. According to an exemplary embodiment, the non-stick inner surface 606 may prevent the food substance 610 from sticking to a surface while cooking in the oven. According to an exemplary embodiment, the cover 604 may be placed on a rack surface 602 so the non-stick inner surface 606 of the cover 604 is facing upwards.

According to an exemplary embodiment, the cover 604 may support an exemplary food substance, such as, e.g., but not limited to, an exemplary pizza 610. In an exemplary embodiment, the pizza 610 may include a top 612 and a bottom 614. According to an exemplary embodiment, the top 612 of the pizza may include the toppings, and the bottom 614 of the pizza may be the crust of the pizza. In an exemplary embodiment, the pizza 610 may be placed upside down so that top 612 of the pizza may contact the non-stick inner surface 606 of the cover 604, and the pizza bottom 614 may face up. So as to prevent the toppings from falling off the pizza when inverted, the cover 604 may be placed over the top 612 of the pizza prior to inverting the pizza and placing it on exemplary rack 602.

FIG. 6B depicts an exemplary embodiment of a side view 650 of a pizza being removed from an oven rack 602 according to an exemplary embodiment of the present invention. In an exemplary embodiment, the pizza 610 and the cover 604 may be removed from the oven with a food substance flipping apparatus 100. According to an exemplary embodiment, the first surface 140 of a food substance flipping apparatus 100 may be placed over the pizza bottom 614. In an exemplary embodiment, the second surface 160 of a food substance flipping apparatus may be placed under a cover 604. According to an exemplary embodiment, the first surface 140 and the second surface 160 may then be brought together to engage and grasp the pizza and cover there between.

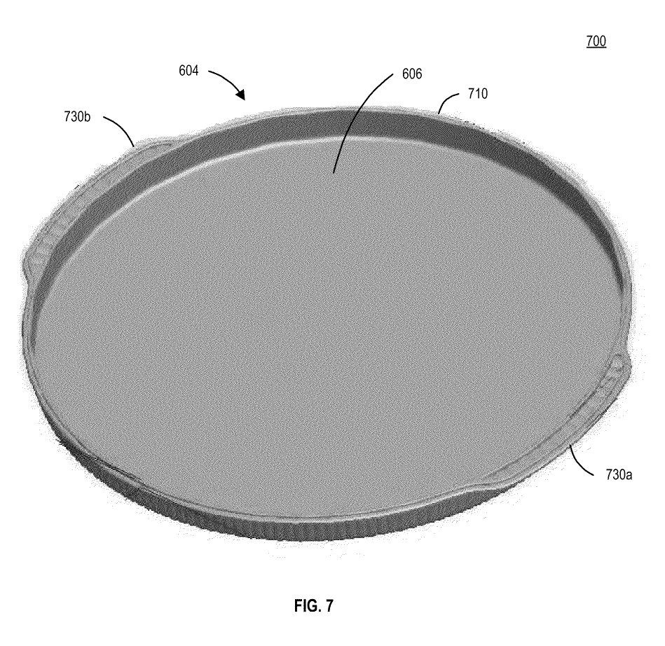

FIG. 7 depicts an exemplary embodiment of an isometric view 700 of an exemplary food substance cover 604 according to an exemplary embodiment of the present invention. In an exemplary embodiment, the cover 604 may be substantially circular or substantially shaped like a pizza. According to an exemplary embodiment, a cover wall 710 may comprise the borders of a non-stick inner surface 606. In an exemplary embodiment, the cover wall 710 may retain a food substance within the cover wall 710. In an exemplary embodiment, one or more cover handles 730a and 730b (hereinafter collectively referred to as 730) may extend from the cover wall 710. According to an exemplary embodiment, the cover handles 730 may permit a user to hold the cover 604 by the handles 730. In an exemplary embodiment, the cover may be made of light flexible silicone with a melting temperature of e.g., but not limited to, in excess of between 675° F. and 930° F.

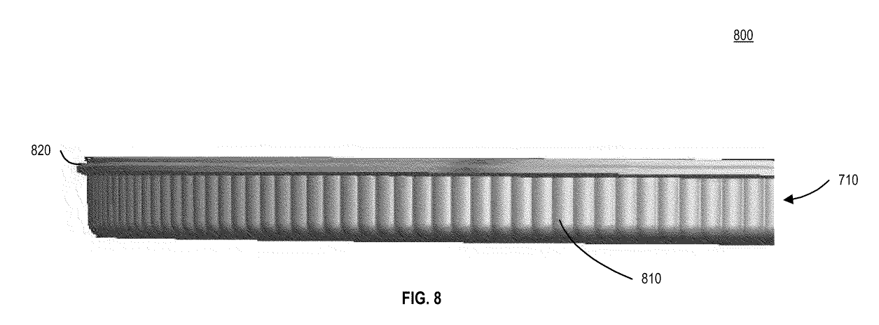

FIG. 8 depicts an exemplary embodiment of a side view 800 of an exemplary food substance cover 604 according to an exemplary embodiment of the present invention. According to an exemplary embodiment, the cover wall 710 may comprise a plurality of ridges 810. In an exemplary embodiment, the ridges 810 may provide reinforcement to the cover wall 710 so that the cover wall 710 may naturally stand upright on its own. According to an exemplary embodiment, the cover handles 730 may also include a plurality of ridges to reinforce the handles 730 so they may naturally extend from the cover wall 710. In an exemplary embodiment, the cover 604 may be colored. According to an exemplary embodiment, the cover color may be chosen to match an oven. According to an exemplary embodiment, the cover 604 may be colored, e.g., but not limited to, red, white, blue, black, gray, etc.

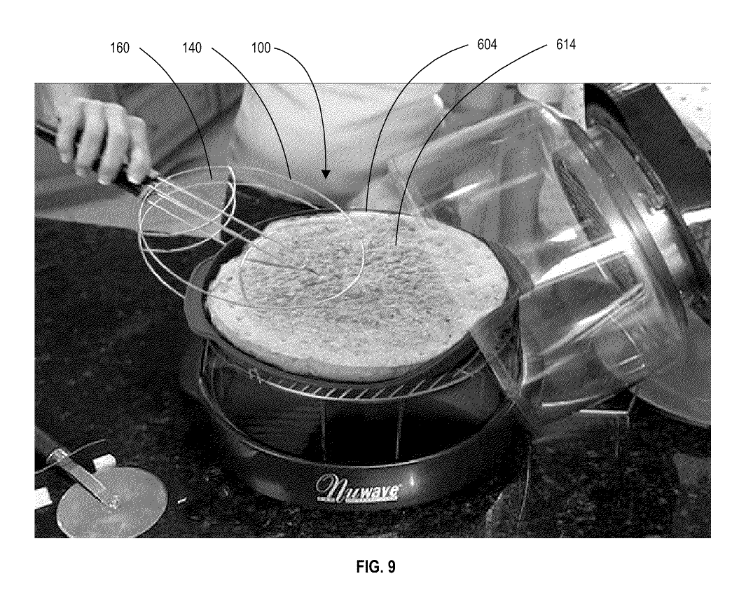

FIG. 9 depicts an exemplary embodiment of an image of an isometric view of a user using exemplary surfaces 140, 160 of an exemplary food substance flipping apparatus 100 grasping a pizza 110 and cover 604 (not labeled), according to an exemplary embodiment of the present invention. According to an exemplary embodiment, the cover 604 may be placed on the pizza. In an exemplary embodiment, the cover 604 may be placed on top of the oven rack so the pizza's bottom 614 faces up. In an exemplary embodiment, the food substance flipping apparatus 100 may manipulated to grasp the cover and pizza by placing the first surface 140 of the apparatus 100 above the pizza bottom and the second surface 160 of the apparatus 100 between the cover bottom and the oven rack (as shown).

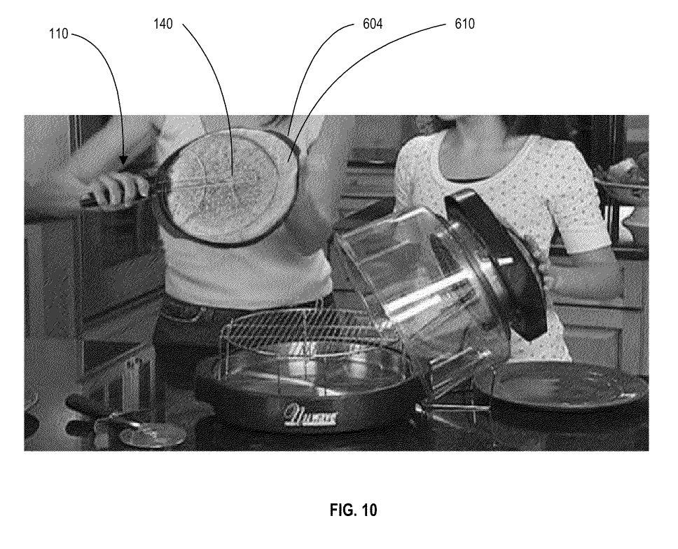

FIG. 10 depicts an exemplary embodiment of an exemplary image of an isometric view of a user rotating or flipping a pizza with an exemplary food substance flipping apparatus, according to an exemplary embodiment of the present invention. In an exemplary embodiment, the cover 604 and pizza 610 may be grasped and flipped by rotating along the axis of length of the handle 110.

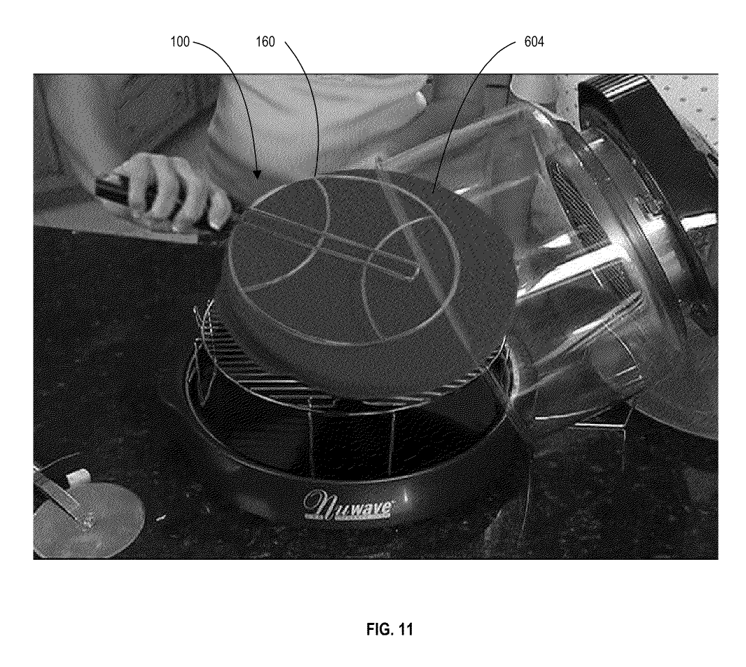

FIG. 11 depicts an exemplary embodiment of an exemplary image of an isometric view of a user placing a pizza after flipping back in an oven with an exemplary food substance flipping apparatus 100, according to an exemplary embodiment of the present invention. In an exemplary embodiment, the cover 604 and pizza 610 may be flipped or rotated so that the bottom of the cover 604 faces up. According to an exemplary embodiment, the cover 604 and pizza 610 may then be returned to the oven rack as shown.

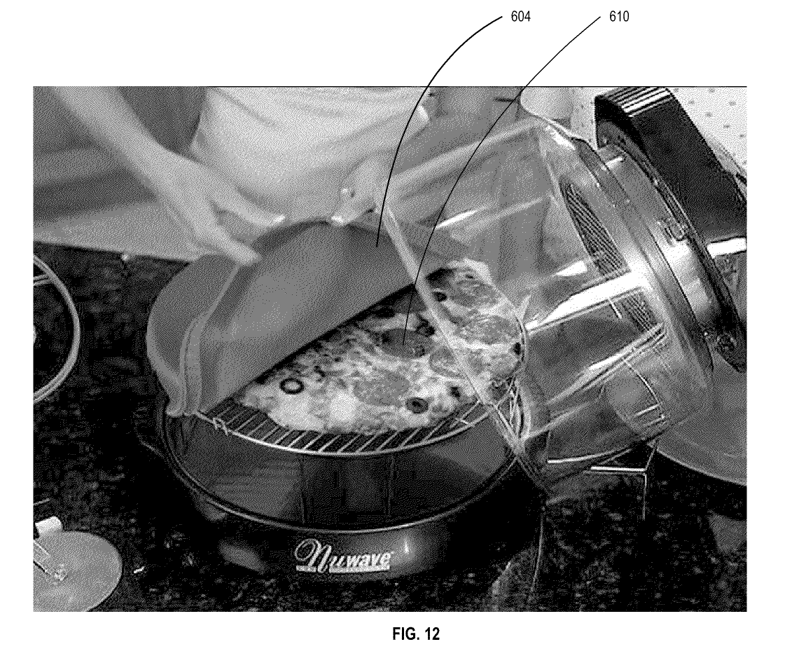

FIG. 12 depicts an exemplary embodiment of an isometric view of removing a cover 604 from a pizza 610 according to an exemplary embodiment of the present invention. In an exemplary embodiment, the cover 604 may be peeled back from the pizza 610. According to an exemplary embodiment, the pizza top 612 may then be heated until fully cooked.

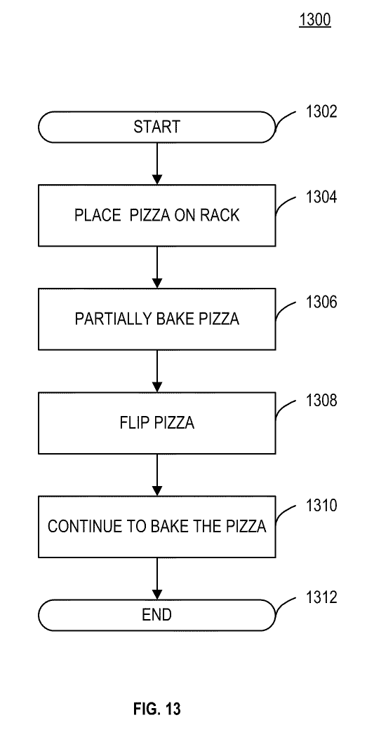

FIG. 13 depicts an exemplary embodiment of an exemplary flowchart 1300 of a method of baking pizza with a food substance flipping apparatus 100 according to an exemplary embodiment of the present invention. According to an exemplary embodiment, the method may start with 1302 and may continue immediately with 1304. In 1304, the user may place a pizza on a rack 602 surface of an oven. From 1304, flow diagram 1300 may continue with 1306. In an exemplary embodiment, the pizza may then be partially baked in 1306 in the oven. From 1306, flow diagram 1300 may continue with 1308. According to an exemplary embodiment, the partially baked pizza may then in 1308 be flipped with a food substance flipping apparatus 100 and the partially baked pizza may be replaced on the rack 602 surface with the partially baked pizza's alternate side facing up. From 1308, flow diagram 1300 may continue with 1310. In an exemplary embodiment, in 1310, the partially baked pizza may then be continued to be baked. From 1310, flow diagram 1300 may continue with 1312, where the flow chart may end.

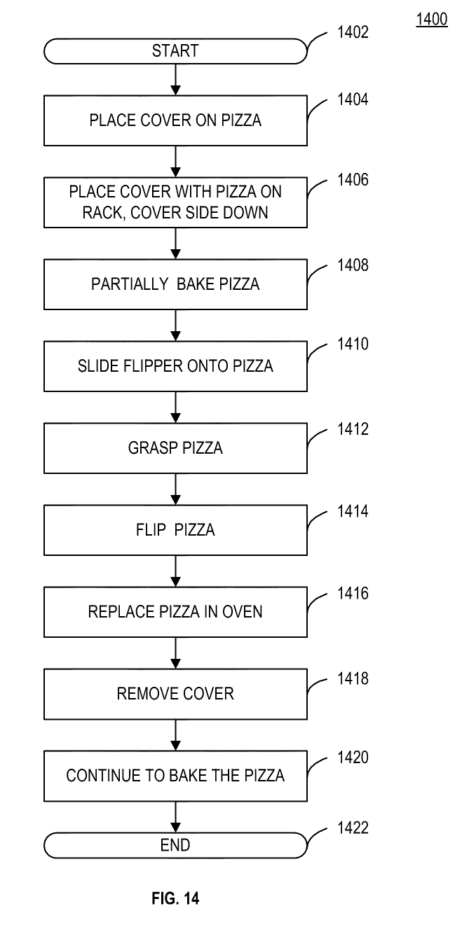

FIG. 14 depicts an exemplary embodiment of a flowchart 1400 of an expanded method of baking pizza with a food substance flipping apparatus 100 according to an exemplary embodiment of the present invention. According to an exemplary embodiment, the method may start with 1402 and may continue immediately with 1404. In 1404, a cover may be placed on a pizza. From 1404, flow diagram 1400 may continue with 1406. In 1406, the cover and pizza may be placed on a rack, with an inner nonstick surface of the cover facing up and the pizza on top. From 1406, flow diagram 1400 may continue with 1408. In 1408, according to an exemplary embodiment, the pizza 610 may then be partially baked. In 1408, in an exemplary embodiment, the pizza 610 may be partially baked until the crust of the pizza is a light brown color. From 1408, flow diagram 1400 may continue with 1410. In 1410, according to an exemplary embodiment, the food substance flipping apparatus 100 may then be slid between the cover 604 and the rack surface 602, and over the partially baked pizza 610. From 1410, flow diagram 1400 may continue with 1412. In 1412, in an exemplary embodiment, the food substance flipping apparatus 100 may then be closed onto the partially baked pizza to grasp the pizza. In an exemplary embodiment, the first surface 140 and second surface 160 of the food substance flipping apparatus 100 may then be locked into position with a locking mechanism (see FIG. 5). From 1412, flow diagram 1400 may continue with 1414. In 1414, according to an exemplary embodiment, the partially baked pizza 610 may then be flipped or rotated with the food substance flipping apparatus 100 along a horizontal axis of the handle until the top of the pizza 610 covered by cover 604 faces upwards. From 1414, flow diagram 1400 may continue with 1416. In 1416, in an exemplary embodiment, the partially baked pizza may then be placed back in the oven with the pizza's top 612 facing up. According to an exemplary embodiment, the first surface 140 and second surface 160 of the food substance flipping apparatus 100 may then be unlocked. In an exemplary embodiment, the two surfaces 140, 160 of the food substance flipping apparatus 100 may separate and release the pizza. From 1416, flow diagram 1400 may continue with 1418. In 1418, according to an exemplary embodiment, the cover 604 may then be removed from the pizza. From 1418, flow diagram 1400 may continue with 1420. In 1420, in an exemplary embodiment, the pizza 610 may then be continued to be baked until fully baked. From 1420, flow diagram 1400 may continue with 1422, and in 1422, flow diagram 1400 may end.

According to an exemplary embodiment, the first handle portion 120 and second handle portion 130 of the handle 110 of the food substance flipping apparatus 100 may be interchanged so that portions of the first handle portion 120 may, instead, be portions of the second handle portion 130, and vice versa. In an exemplary embodiment, the first surface 140 and second surface 160 of the food substance flipping apparatus may also be interchanged. According to an exemplary embodiment, the oven may be a top heating oven such as, e.g., but not limited to, a NuWave Oven Pro, manufactured by and available from Hearthware Home Products of Gurnee, Ill., USA. In an exemplary embodiment, the oven may include, e.g., but not limited to, a heating element suspended above the pizza.

According to an exemplary embodiment, the oven may have a clear enclosure permitting a user to view the pizza while the pizza is being baked. In an exemplary embodiment, a recommendation may be to flip pizzas no larger than about 11″ in diameter. According to an exemplary embodiment, the rack may be a reversible rack and may be positioned as a 4″ rack on a liner pan of the oven.

According to an exemplary embodiment, the pizza baking times may vary depending on the pizza. In an exemplary embodiment, the recommended baking time for a thin crust pizza may be about 15 to about 18 minutes upside down and about 3 to about 5 minutes right side up. According to an exemplary embodiment, the recommended baking time for a regular crust pizza may be about 18 to about 20 minutes upside down and about 3 to about 5 minutes right side up. In an exemplary embodiment, the recommended baking time for a thick crust pizza may be about 20 to about 23 minutes upside down and about 3 to about 5 minutes right side up.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A food substance flipping apparatus, comprising:
a handle support member fixedly attached to a handle of the flipping apparatus; and
an outer support member coupled to the handle support member disposable to engage a food substance.

2. The food substance flipping apparatus according to claim 1, wherein the outer support member is coupled to the handle support member by an inner support member fixedly attaching the handle support member to the outer support member.

3. The food substance flipping apparatus according to claim 1, further comprising:
a second handle support member fixedly attached to the handle of the flipping apparatus; and
a second outer support member coupled to the second handle support member disposable to engage the food substance.

4. The food substance flipping apparatus according to claim 3, wherein the second outer support member is coupled to the second handle support member by an inner support member fixedly attaching the second handle support member to the second outer support member.

5. The food substance flipping apparatus according to claim 3, wherein the handle comprises a first handle portion coupled to the handle support member and a second handle portion coupled to the second handle support member.

6. The food substance flipping apparatus according to claim 5, wherein the first handle portion and the second handle portion are coupled on an end of the handle distal from the handle support member.

7. The food substance flipping apparatus according to claim 6, wherein the first handle portion and the second handle portion are coupled by a hinged connection.

8. The food substance flipping apparatus according to claim 6, further comprising a resilient member biased to separate the outer support member and the second outer support member.

9. The food substance flipping apparatus according to claim 6, further comprising a locking mechanism adapted to lock the outer support member in a predetermined position with respect to the second outer support member.

10. The food substance flipping apparatus according to claim 9, wherein the locking mechanism comprises a column extending from the second handle portion and comprising at least one slot, and a sliding tab located on the first handle portion and engagable with the at least one slot.

11. The food substance flipping apparatus according to claim 1, wherein the outer support member is shaped substantially circular.

12. The food substance flipping apparatus according to claim 1, wherein the outer support member defines a surface area enclosed by the member, wherein the surface area comprises at most about 20% of support members.

13. The food substance flipping apparatus according to claim 1, wherein the outer support member comprises cast iron wire.

14. The food substance flipping apparatus according to claim 1, wherein the shape of the handle support member is substantially u-shaped.

15. The food substance flipping apparatus according to claim 2, wherein the shape of the inner support member is substantially curved.

16. A method of baking a pizza, comprising:
placing a pizza on a rack surface of an oven;
partially baking the pizza;
flipping the partially baked pizza over with a food substance flipping apparatus and replacing the partially baked pizza on the rack surface; and
continuing to bake the pizza.

17. The method of claim 16, further comprising:
covering a top of the pizza with an inner nonstick surface of a cover before placing the pizza on said rack surface.

18. The method of claim 17, wherein the cover comprises parchment paper.

19. The method of claim 17, wherein the inner nonstick surface of said cover comprises at least one of: silicone, enamel, teflon or metal.

20. The method of claim 17, wherein the cover comprises a re-usable dish.

21. The method of claim 20, wherein the cover comprises a silicone dish comprising:
the inner nonstick surface substantially shaped like a pizza;
a cover wall with a plurality of vertical reinforcing ridges, the cover wall bordering the edges of the inner nonstick surface; and
one or more handles extending from the cover wall.

22. The method of claim 16, further comprising:
placing a cover on the pizza and placing the cover side down on the rack surface with a inner nonstick surface of the cover facing upwards toward the pizza, and with the pizza on top;
allowing the pizza to partially bake;
positioning the food substance flipping apparatus between the cover and the rack surface, and over the partially baked pizza;
engaging the partially baked pizza with the food substance flipping apparatus;
flipping the partially baked pizza with the food substance flipping apparatus;
replacing the partially baked pizza on the rack surface;
removing the cover from the pizza; and
baking the pizza further.

23. The method of claim 16, wherein baking the pizza comprises heating the pizza with a heating element oriented above the pizza.
